(19) United States
(12) Patent Application Publication
(10) Pub. No.: US 2007/0009126 A1
(43) Pub. Date: Jan. 11, 2007

(54) Hearing aid and method for its adjustment

(76) Inventor: Eghart Fischer, Schwabach (DE)

Correspondence Address: SCHIFF HARDIN, LLP;PATENT DEPARTMENT, 6600 SEARS TOWER, CHICAGO, IL, 60606-6473, US

(21) Appl. No.: 11/485,050

(22) Filed: Jul. 11, 2006

(30) Foreign Application Priority Data
Jul. 11, 2005 (DE) 10 2005 032 273.5

(51) Int. Cl. H04R 25/00

(52) U.S. Cl. 381/315

(57) ABSTRACT

A hearing aid and appertaining method of adjustment permit adjusting a hearing aid more conveniently and more specifically. For this purpose, parameters for real hearing situations are stored in a storage device in the hearing aid or in the remote control for an adjustment procedure by the hearing aid wearer him- or herself. These hearing examples are then reproduced to the hearing aid wearer for the adjustment procedure. The hearing aid wearer therefore does not have to wait for a corresponding hearing situation in his surrounding area for the adjustment process and can repeat the adjustment process as required.

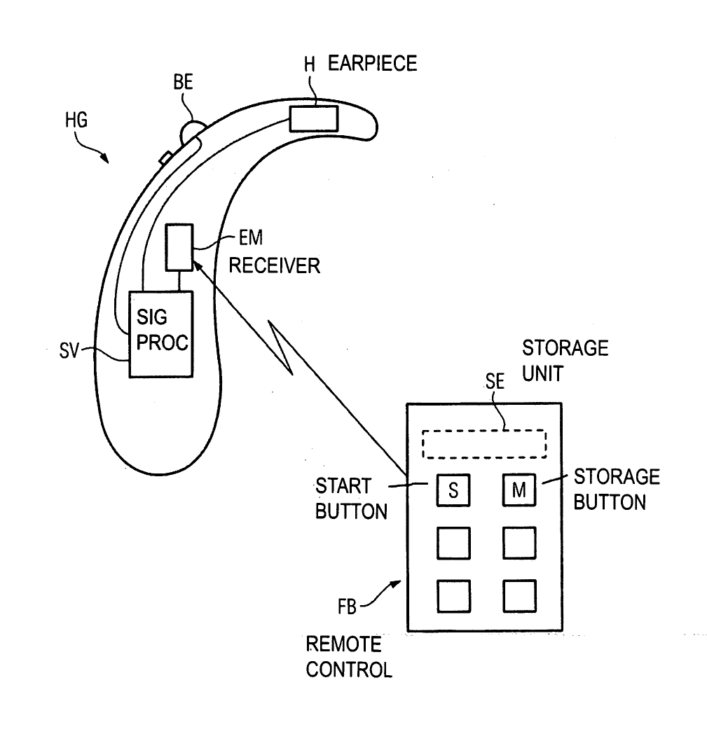

### BACKGROUND

The present invention relates to a hearing aid having a storage device for storage of signal data, a signal processing device for outputting the signal data from the storage device, and a control device for adjustment of the signal processing device. The present invention furthermore relates to a hearing aid system having a hearing aid, to a remote controller and, finally, to a method for adjustment of the hearing aid.

Until now, it has not been possible for a hearing aid wearer, or has been possible only to a very restricted extent, to adjust the transmission characteristic of his hearing aid as appropriate for his own wishes and requirements, and at any time, that is to say, particularly without having to use the help of an acoustician. The reason for this is due to the range and complexity of the hearing aid parameters, which can be viewed only by appropriately trained specialist personnel. In particular, the hearing aid wearer can often not objectively decide what the hearing situation is in order to allow him to appropriately adjust his hearing aid.

With most hearing aids, the only provision that has been made in the past is for the hearing aid wearer to be able to adjust the volume on his hearing aid himself. The current hearing situation may be defined by a classifier, with the selected volume relating to the current hearing situation being stored.

U.S. Pat. Nos. 5,202,927; 5,710,819; 4,947,432; and 5,303,306 each disclose the transmission of control signals to hearing aids in order to adjust them. In particular, appropriate monitoring parameters can be transmitted from a remote control to the hearing aid.

Furthermore, the German patent document no. DE 44 27 216 A1 describes a method for tinnitus supply, in which an acoustic concealment signal, which has spectral components of the tinnitus signal, is selected or produced, and is offered to the tinnitus patient while the tinnitus is occurring. Natural tonal properties which vary over time are used as the concealment signal.

Furthermore, the Australian patent document no. AU 199858308 A1 and German patent document no. DE 32 05 685 C2 disclose the use of synthetic test signals for adjustment of hearing aids. This allows a hearing aid wearer to carry out conventional tone audiometry himself. All cited references are herein incorporated by reference.

However, these adjustment capabilities have the disadvantage that the natural hearing situations differ from the synthetic test signals, so that the settings can be implemented only approximately.

### SUMMARY

The object of the present invention is thus to improve the adjustment capabilities for the hearing aid wearer himself.

According to various embodiments of the invention, this object is achieved by a hearing aid having a storage device for storage of signal data, a signal processing device for outputting the signal data from the storage device, and a control device for adjustment of the signal processing device, in which the signal data comprises test audio data relating to a plurality of classes of characteristic hearing situations, the test audio data in a desired class can at least partially be output via the signal processing device by operation of the control device, the signal processing device can be adjusted while the audio data is being output, and the setting of the signal processing device for the desired class can be stored.

Furthermore, various embodiments of the invention provide a hearing aid system having a hearing aid and a remote control, in which the remote control has a storage device for storage of test audio data relating to a plurality of classes of characteristic hearing situations and for transmission of the test audio data in a desired class to the hearing aid, the hearing aid can be adjusted by the hearing-aid wearer while the test audio data is being replayed, and the setting of the hearing aid for the desired class can be stored in the hearing aid.

Various embodiments of the invention likewise provide a method for adjustment of a hearing aid by storage of test audio data which represents a plurality of classes of characteristic hearing situations, reproduction of the stored test audio data in a desired class by way of the hearing aid to be adjusted, adjustment of the hearing aid on the basis of the reproduced test audio data by the hearing aid wearer in accordance with his individual requirements, and storage of the setting of the hearing aid for the desired class in the hearing aid.

Accordingly, it is thus possible to offer the hearing aid wearer so-called real-life test signals which correspond to a characteristic hearing situation, for adjustment purposes. This allows the hearing aid wearer to carry out the adjustment process more specifically and more accurately. In this case, it is advantageous for a sequence of audio or test signals to comprise signals from all the classifier classes, i.e., the hearing situations which can be distinguished by the hearing aid classifier, in each case at different levels.

Consequently, the hearing aid wearer no longer has to wait, as was normal until now, for, for example, the hearing situation of “quiet music” to occur in his natural environment, thus allowing him for the first time to adjust his hearing aid. In fact, according to embodiments of the invention, he can now carry out the adjustment procedure before entering a natural situation, such as this, whenever he wishes to and this can be done in a reproducible manner. The user can then modify hearing aid parameters as a function of the class and level, using natural hearing situations.

These modifications are then stored in the hearing aid, and are immediately effective. By way of example, the hearing aid wearer can thus select the sound as follows when offered objectively quiet music: more high-tones, reduced mid-tones and more low-tones. The hearing aid is preferably controlled by way of a remote control. This allows the hearing aid wearer to adjust the hearing aid conveniently, using the remote control.

The test audio data advantageously comprises an announcement and a subsequent hearing example. This makes it possible to ensure that the hearing aid wearer correctly assesses and classifies the subsequently reproduced hearing example.

In accordance with one likewise preferred development, the reproduction of the test audio data is repeated until the hearing aid wearer pushes an appropriate control button. The hearing aid wearer can thus spend as long as he desires in adjustment of the hearing aid for specific hearing situations.

The adjustment range of the hearing aid can also be predetermined as a function of reproduced audio data. This is particularly advantageous when the hearing aid wearer incorrectly assesses the audio signals offered and thus, for example, would set the volume too high for the “quiet music” hearing situation.

### DESCRIPTION OF THE DRAWING

The present invention will be explained below in more detail with reference to the attached drawings, which is a pictorial block diagram of one hearing aid system according to an embodiment of the invention.

### DETAILED DESCRIPTION OF THE PREFERRED EMBODIMENTS

The exemplary embodiment which will be described in more detail in the following text represents one preferred embodiment of the present invention.

Accordingly, the hearing aid wearer can adjust the signal processing of his hearing aid himself by actions on his hearing aid or on a remote control. Primarily, two components are used for this purpose:

1. Test signals which correspond to a real hearing situation, and

2. Control elements on the hearing aid or on the remote control for adjustment of the hearing aid by the hearing aid wearer.

The test signals and hearing examples correspond to all the major environmental situations to which a hearing aid wearer is typically subject. One hearing example, e.g., is thus provided for the hearing situation of a speech in a quiet environment, quiet music, etc., as a test signal. These test signals are stored in a storage unit SE in a remote control FB in accordance with the example illustrated in the FIGURE. The remote control FB may transmit the test signals wirelessly to a hearing aid HG, which has an appropriate receiver EM for this purpose. In one alternative embodiment, the storage unit for storage of the test signals can also be provided directly in the hearing aid.

The receiver EM in the hearing aid HG transmits the received test signals to signal processing SV, which drives an earpiece H. The signal processing SV can be adjusted via a control element BE on the hearing aid HG. It is also possible to adjust the signal processing SV via the remote control FB. For example, appropriate adjustment buttons on the remote control can be used to set “volume”/“treble”/“bass” or else only “volume”.

By way of example, the adjustment process can be started by pushing the button S on the remote control FB. The selected setting can be stored by pushing the button M.

An adjustment process is described below in detail in the following text. In this case, a sequence of test signals or hearing examples is advantageously played to the hearing aid wearer, using the hearing aid, as soon as he pushes the start button S on the remote control FB. Each hearing example contained in the sequence is introduced by an announcement. This announcement is, for example: “this is quiet music”. The hearing example including the announcement is repeated until the hearing aid wearer pushes a further button or the storage button M. Until then, the hearing aid wearer has the capability to adjust the volume for the specific signal within a predetermined framework as is pleasant for him. The announcement and the restriction to the adjustment capability for the volume are important in order to prevent the hearing aid wearer from accidentally, for example, “turning up” quiet signals to a normal volume.

Once the hearing aid wearer has pushed the further button or storage button M in, the next hearing example, which represents a different hearing situation, is reproduced. The sequence on the hearing examples to be offered may appear as follows:

speech in a quiet environment (normal, quiet, loud)

speech with interference noise (normal, quiet, loud)

traffic noise (normal, quiet, loud)

natural noise (normal, quiet, loud)

music (normal, quiet, loud)

silence (microphone noise)

telephone

Once a sequence of hearing examples such as this has been run through, this results in class-dependent and level-dependent modification of the gain and compression parameters in the hearing aid, which can be used by way of example as a preset for more comprehensive learning and training algorithms. The adjustment procedure can be repeated, restarted and terminated prematurely as often as desired.

Furthermore, a “reset” option may be provided, via which the parameters can be reset again to the initial setting set by the acoustician, in order, for example, to cancel incorrect actions which occurred initially.

According to various embodiments of the invention, quasi-real hearing examples are used for the adjustment procedure and can be reproduced at any desired time. In comparison to known methods in which adjustment capabilities are provided only during real, actual hearing situations, this offers the following advantages:

The training procedure according to embodiments of the invention with quasi-real hearing examples is not in the form of a permanent correction to non-optimal settings, which are thus disturbing and tedious, but in the form of a deliberately selected action which the hearing aid wearer can carry out with full concentration, at any time, and in his desired environment.

Since the test signals are reproducible, they are imprinted after a short time, which, of course, is not the case with real signals. The more often the hearing aid wearer runs through the training procedure, the more specifically and reliably he can carry out the desired modification to the sound of his hearing aid.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The term “mechanism” construed broadly and is defined to mean any physical or software implemented entity including combination entities.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various FIGURES presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” “critical”. Numerous modifications and adaptations will be readily apparent to those skilled in this art without departing from the spirit and scope of the present invention.

What is claimed is:

1. A hearing aid, comprising:
a storage device comprising a signal data store, wherein the signal data comprises test audio data relating to a plurality of classes of characteristic hearing situations;
a signal processing device comprising an output via which the signal data from the storage device is output; and
a control device having an adjustment mechanism in communication with the signal processing device, the signal processing device having a mechanism to operate the control device to at least partially output the test audio data in a desired class, the signal processing device being adjustable while the audio data is being output, and a storage mechanism that can store a setting of the signal processing device for the desired class.

2. The hearing aid as claimed in claim 1, wherein the control device comprises a remote control.

3. The hearing aid as claimed in claim 1, wherein the test audio data comprises an announcement and a subsequent tone example.

4. The hearing aid as claimed in claim 3, further comprising a mechanism for repeating a reproduction of the test audio data until the hearing aid wearer activates an appropriate control.

5. The hearing aid as claimed in claim 3, wherein an adjustment range of the hearing aid is predetermined as a function of the repeated test audio data.

6. A hearing aid system, comprising:
a hearing aid;
a remote control comprising a storage device for storage of test audio data relating to a plurality of classes of characteristic hearing situations and for transmission of test audio data in a desired class to the hearing aid, the hearing aid comprising a wearer adjustable adjustment mechanism that can be adjusted by the hearing-aid wearer while the test audio data is being replayed;
a setting mechanism that sets values for the desired class; and
a setting storage area that stores the values for the desired class.

7. The hearing aid system as claimed in claim 6, further comprising:
a remote control via which the hearing aid can be adjusted.

8. The hearing aid system as claimed in claim 6, wherein the test audio data comprises an announcement and a subsequent tone example.

9. The hearing aid system as claimed in claim 8 further comprising a mechanism for repeating a reproduction of the test audio data until the hearing aid wearer activates an appropriate control.

10. The hearing aid system as claimed in claim 8, wherein an adjustment range of the hearing aid is predetermined as a function of the repeated test audio data.

11. A method for adjusting hearing aid, comprising:
storing test audio data which represents a plurality of classes of characteristic hearing situations;
reproducing the stored test audio data in a desired class with the hearing aid to be adjusted;
adjusting the hearing aid based on the reproduced test audio data by the hearing aid wearer in accordance with his or her individual requirements; and
storing the setting of the hearing aid for the desired class in the hearing aid.

12. The method as claimed in claim 11, wherein a remote control is utilized for adjusting the hearing aid.

13. The method as claimed in claim 11, further comprising:
providing an announcement and subsequent tone example as at least a part of the test audio data.

14. The method as claimed in claim 11, further comprising:
repeating the reproduction of the test audio data until the hearing aid wearer activates an appropriate control.

15. The method as claimed in claim 14, further comprising:
predetermining an adjustment range of the hearing aid as a function of the repeated test audio data.
